(19) United States
(12) Patent Application Publication
(10) Pub. No.: US 2025/0036497 A1
(43) Pub. Date: Jan. 30, 2025

(54) CONTAINERIZED MICROSERVICE ARCHITECTURE FOR MANAGEMENT APPLICATIONS

(71) Applicant: VMWARE, LLC., Palo Alto, CA (US)

(72) Inventors: VARUN RAJASEKAR, Chennal (IN); CHANDRIKA MUTALIK, Palo Alto, CA (US); AKASH KODENKIRI, Bangalore (IN); SHWETA MISHRA, Bangalore (IN); KRISHNENDU GORAI, Bangalore (IN)

(21) Appl. No.: 18/380,658

(22) Filed: Oct. 17, 2023

(30) Foreign Application Priority Data
Jul. 25, 2023 (IN) 202341050100

(51) Int. Cl. G06F 9/54; G06F 21/60

(52) U.S. Cl. CPC G06F 9/547; G06F 21/602

(57) ABSTRACT

An example method for implementing a microservice architecture for a management application may include deploying a first service of the management application on a first container running on a container host. Further, the method may include employing a service-to-service communication mechanism to control communication between the first service and a second service of the management application. Furthermore, the method may include employing an inter-process communication mechanism to control communication between the first service and the container host using named pipes and employing a proxy to control communication between the first service and an external application in an external device. Further, the method may include enabling a container orchestrator to monitor and manage the first service.

### RELATED APPLICATIONS

Benefit is claimed under 35 U.S.C. 119 (a)-(d) to Foreign application No. 202341050100 filed in India entitled “CONTAINERIZED MICROSERVICE ARCHITECTURE FOR MANAGEMENT APPLICATIONS”, on Jul. 25, 2023, by VMware, Inc., which is herein incorporated in its entirety by reference for all purposes.

### TECHNICAL FIELD

The present disclosure relates to computing environments, and more particularly to methods, techniques, and systems for implementing a containerized microservice architecture for management applications.

### BACKGROUND

In a software-defined data center (SDDC), virtual infrastructure, which includes virtual machines (VMs) and virtualized storage and networking resources, is provisioned from hardware infrastructure that includes a plurality of physical servers, storage devices, and networking devices. The provisioning of the virtual infrastructure is carried out by a centralized management application that communicates with virtualization software (e.g., a hypervisor) installed in the physical servers. The centralized management application includes various management services to manage virtual machines and physical servers centrally in virtual computing environments.

A management appliance, such as VMware vCenter® server appliance, may host such centralized management application and is widely used to provision SDDCs across multiple clusters of hosts. Each cluster is a group of hosts that are managed together by the centralized management application to provide cluster-level functions, such as load balancing across the cluster by performing VM migration between the hosts, distributed power management, dynamic VM placement according to affinity and anti-affinity rules, and high availability (HA). The centralized management application also manages a shared storage device to provision storage resources for the cluster from the shared storage device. In such virtual computing environments, the centralized management services may be communicatively coupled together and act as a single platform for managing the virtualization infrastructure. Further, the management services may run within a single management appliance that enables users to manage multiple physical servers and perform configuration changes from a single pane of glass.

### BRIEF DESCRIPTION OF THE DRAWINGS

FIG. 1 is a block diagram of an example container platform, depicting a microservices architecture for a management application;

FIG. 2 is a block diagram of the example container platform of FIG. 1, depicting named pipes between a containerized service and the container platform;

FIG. 3 is a block diagram of the example container platform of FIG. 1, depicting a container orchestrator to mount configuration files and database to a container during startup of the container;

FIG. 4 is a block diagram of an example distributed system, depicting containerized services deployed across multiple server platforms;

FIG. 5 is an example schematic diagram, depicting a container orchestrator and patcher to upgrade a containerized service;

FIG. 6 is a flow diagram illustrating an example method for implementing a microservice architecture for a management application; and

FIG. 7 is a block diagram of an example management node 700 including non-transitory computer-readable storage medium 704 storing instructions to transform a management application into a microservices architecture.

The drawings described herein are for illustrative purposes and are not intended to limit the scope of the present subject matter in any way.

### DETAILED DESCRIPTION

Examples described herein may provide an enhanced computer-based and/or network-based method, technique, and system to implement a microservice architecture for a management application in a computing environment. The paragraphs to present an overview of the computing environment, existing methods to manage virtual machines and physical servers in a data center, and drawbacks associated with the existing methods.

The computing environment may be a virtual computing environment (e.g., a cloud computing environment, a virtualized environment, and the like). The virtual computing environment may be a pool or collection of cloud infrastructure resources designed for enterprise needs. The resources may be a processor (e.g., a central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in virtual space being hosted by one or more physical data centers. The virtual computing environment may include multiple physical computers (e.g., servers) executing different computing-instances or workloads (e.g., virtual machines, containers, and the like). The workloads may execute different types of applications or software products. Thus, the computing environment may include multiple endpoints such as physical host computing systems, virtual machines, software defined data centers (SDDCs), containers, and/or the like.

Further, such data centers may be monitored and managed using a centralized management application. VMware® vCenter is an example of the centralized management application. The centralized management application may provide a centralized platform for management, operation, resource provisioning, and performance evaluation of virtual machines and host computing systems in a distributed virtual data center. The centralized management application may include multiple management services to aggregate physical resources from multiple servers and to present a central collection of flexible resources for a system administrator to provision virtual machines in the data center.

In such virtual computing environments, the management services may be communicatively coupled together and act as a single platform for managing the virtualization infrastructure. Further, the management services may run within a single management appliance and are tightly integrated to each other. For example, VMware vCenter® server is a closed appliance that hosts various management services for managing the data center. In this example, multiple management services that are packaged and running on the vCenter® server appliance may include different technologies, such as C++, Java, python, golang, and the like. The management application is delivered and installed/upgraded as a single bundle which can be disruptive. For example, a bug/security fix on one management service may require a new vCenter® server release and/or an entire vCenter® server upgrade.

Further, the management services by design may have a tight coupling with the management appliance itself that makes the management services less mobile and bound to the infrastructure. Further, the tight integration of the management services and the management appliance may prevent migration of the management services to different platforms like the public cloud, physical servers (e.g., VMware® vSphere Hypervisor (ESXi) server), and the like. Instead, the management services need to be implemented as the management appliance.

Examples described herein may provide a method for implementing a microservice architecture for a management application. The method may include deploying a first service of the management application on a first container running on a container host (e.g., a virtual machine, a physical server, and the like). Further, the method may include employing a service-to-service communication mechanism to control communication between the first service and a second service of the management application. Furthermore, the method may include employing an inter-process communication mechanism to control communication between the first service and the container host using named pipes. Also, the method may include employing a proxy to control communication between the first service and an external application in an external device. Upon establishing needed communication for the first service, the method may enable a container orchestrator to monitor and manage the first service.

Thus, examples described herein may provide a solution to convert the management appliance to a true set of independent microservices without compromising on the concept of one management application working coherently. Examples described herein may enable communication between the microservices, zero downtime-upgrade of the microservices, and an ability to view the management application as distributed microservices in a single server platform or across multiple server platforms.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

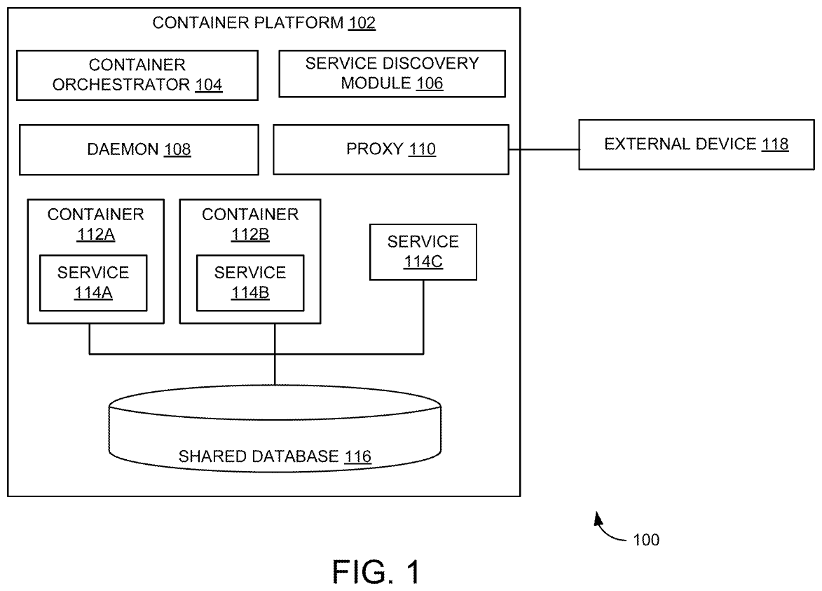

Referring now to the figures, FIG. 1 is a block diagram of an example container platform 102, depicting a microservices architecture for a management application. Example container platform 102 may be a part of a computing environment 100 such as a cloud computing environment (e.g., a virtualized cloud computing environment), a physical computing environment, or a combination thereof. For example, the cloud computing environment may be enabled by vSphere®, VMware's cloud computing virtualization platform. The cloud computing environment may include one or more computing platforms that support the creation, deployment, and management of virtual machine-based cloud applications or services or programs. An application, also referred to as an application program, may be a computer software package that performs a specific function directly for an end user or, in some cases, for another application. Examples of applications may include MySQL, Tomcat, Apache, word processors, database programs, web browsers, development tools, image editors, communication platforms, and the like.

For example, computing environment 100 may be a data center that includes multiple endpoints. In an example, an endpoint may include, but not limited to, a virtual machine, a physical host computing system, a container, a software defined data center (SDDC), or any other computing instance that executes different applications. The endpoint can be deployed either on an on-premises platform or an off-premises platform (e.g., a cloud managed SDDC). The SDDC may refer to a data center where infrastructure is virtualized through abstraction, resource pooling, and automation to deliver Infrastructure-as-a-service (IAAS). Further, the SDDC may include various components such as a host computing system, a virtual machine, a container, or any combinations thereof. An example of the host computing system may be a physical computer. The physical computer may be a hardware-based device (e.g., a personal computer, a laptop, or the like) including an operating system (OS). The virtual machine may operate with its own guest operating system on the physical computer using resources of the physical computer virtualized by virtualization software (e.g., a hypervisor, a virtual machine monitor, and the like). The container may be a data computer node that runs on top of the host's operating system without the need for the hypervisor or separate operating system.

In some examples, container platform 102 may execute containerized services (e.g., services 114A and 114B) of a management application to monitor and manage the endpoints centrally in the virtualized cloud computing infrastructure. The management application may provide a centralized platform for management, operation, resource provisioning, and performance evaluation of virtual machines and host computing systems in a distributed virtual data center. For example, the management application may include multiple management services. An example for the centralized management application may include VMware® vCenter Server™, which is commercially available from VMware.

As shown in FIG. 1, computing environment 100 may include container platform 102 to execute containerized services (e.g., services 114A and 114B) of a management application. In an example, container platform 102 may include a plurality of containers 112A and 112B, each container executing a respective containerized service (e.g., services 114A and 114B). In the example shown in FIG. 1, container platform 102 may include a container orchestrator 104 to deploy a first service 114A and a second service 114B of the management application on a first container 112A and a second container 112B running on container platform 102. Further, some management services of the management application cannot be containerized. For example, some management services (e.g., a service 114C) such as network identity services, may be tied to container platform 102. When a management service is tied to container platform 102's network, then the management service may have to fetch the network identity details from container platform 102 (e.g., a server platform) along with certain other configuration details. In the example shown in FIG. 1, container platform 102 may execute service 114C, which is not containerized.

Further, container platform 102 may include a service discovery module 106 to control communication between containerized services 114A and 114B within container platform 102 using an application programming interface (API)-based communication. For example, a containerized service calls an API that another containerized service exposes, using an inter-service communication protocol like Hypertext Transfer Protocol (HTTP), Google Remote Procedure Call (gRPC), or message brokers Advanced Message Queuing Protocol (AMQP).

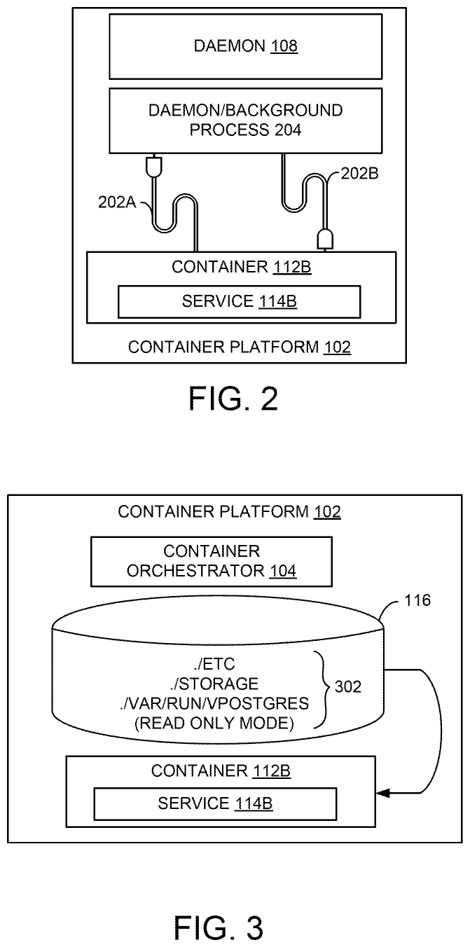

Furthermore, container platform 102 may include a daemon 108 running on container platform 102 to orchestrate communication between containerized services 114A and 114B and container platform 102 using named pipes. An example of inter-process communication (IPC) between containers (e.g., 112A and 112B) and container platform 102 via the named pipes is explained in FIG. 2.

FIG. 2 is a block diagram of example container platform 102 of FIG. 1, depicting named pipes 202A and 202B between containerized service 114B and container platform 102. For example, similarly named elements of FIG. 2 may be similar in structure and/or function to elements described with respect to FIG. 1. The IPC between containers and container platform 102 (e.g., a virtual machine or a physical server) is done via named pipes that are mounted from container platform 102 to the containers.

In the example shown in FIG. 2, named pipes 202A and 202B may be mounted to container 112B. For example, each container of the plurality of containers (e.g., containers 112A and 112B) may include a first named pipe 202A and a second named pipe 202B. In this example, daemon 108 may transmit a command that needs to be executed on container platform 102 from a first container (e.g., container 112B) to container platform 102 through first named pipe 202A and transmit a result associated with an execution of the command from container platform 102 to first container 112B through second named pipe 202B. In this example, a daemon/background process 204 may handle command-line interface (CLI) requests from container 112B via first named pipe 202A. Based on the CLI request, daemon/background process 204 may execute a command on container platform 102 (e.g., a virtual machine or a physical server) and return the result to container 112B via second named pipe 202B.

Thus, commands that need to be executed on container platform 102 can be sent through one end of first named pipe 202A on container 112B's side. This command is then read on the other end of first named pipe 202A by container platform 102, the command is executed, and the result is sent back to container 112B via second named pipe 202B. The IPC communication may facilitate in getting information that is host-specific, such as network details.

Referring back to FIG. 1, container platform 102 may include a proxy 110 running on container platform 102 to control communication between containerized services 114A and 114B and an external device 118. In an example, proxy 110 may enable containerized services 114A and 114B to communicate with outside world. An example of proxy 110 may include an envoy, which is a prominent proxy and networking solution for microservices. The envoy manages network traffic that moves in and out of containers 112A and 112B. For example, the envoy may be used for platform-to-platform communication between the containerized services, containerized service communication to outside world for downloading, end user communication with the containerized services, and the like. For example, when the containerized services are running on different hosts, the envoy manages routing of requests between one host to another.

Further, container platform 102 may include a common data model (CDM) (e.g., shared database 116) that is shared between first container 112A and second container 112B that runs containerized services 114A and 114B, respectively, of the management application. For example, the CDM may include database and configuration data of first service 114A and second service 114B. An example of database and configuration data is explained in FIG. 3.

FIG. 3 is a block diagram of example container platform 102 of FIG. 1, depicting container orchestrator 104 to mount configuration files and database (e.g., database and network/configuration details 302) to container 112B during startup of container 112B. For example, similarly named elements of FIG. 3 may be similar in structure and/or function to elements described with respect to FIG. 1. As shown in FIG. 3, container platform 102 (i.e., a host platform that hosts containers 112A and 112B) may only hold database and network/configuration details 302 that are common to all the containerized services in shared database 116. In the example shown in FIG. 3, database and network/configuration details 302 may include configuration files such as ./etc, log files such as ./var and ./run, storage file such as ./storage, database such as ./vpostgres, and the like. Since database and network/configuration details 302 are stored in well-defined hardcoded locations on the container platform 102, they can be mounted onto containers 112A and 112B during their startup. At the time of starting containers 112A and 112B, only configuration files and database/vpostgres are mounted from container platform 102 to containers 112A and 112B using container runtime. Further, each service may have its own schema, so that there is no security or corruption issue in sharing database 116 across the containerized services.

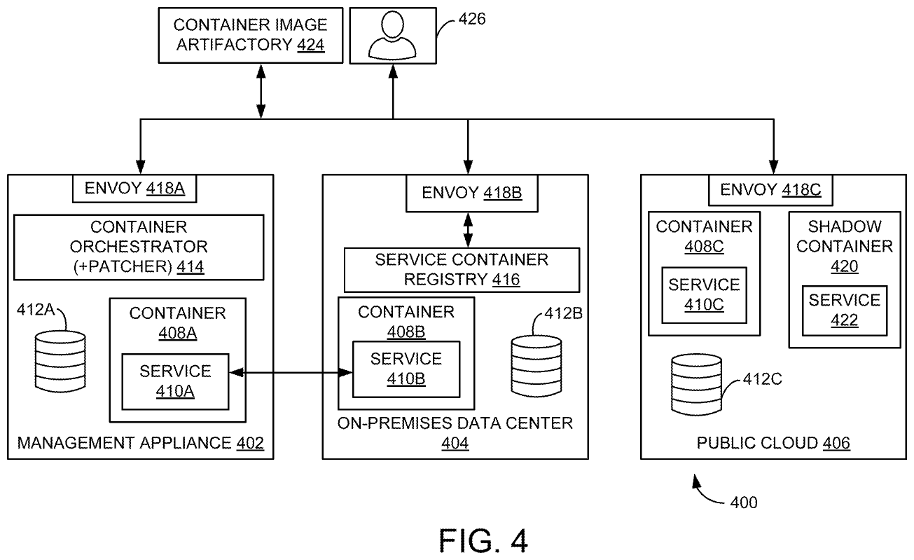

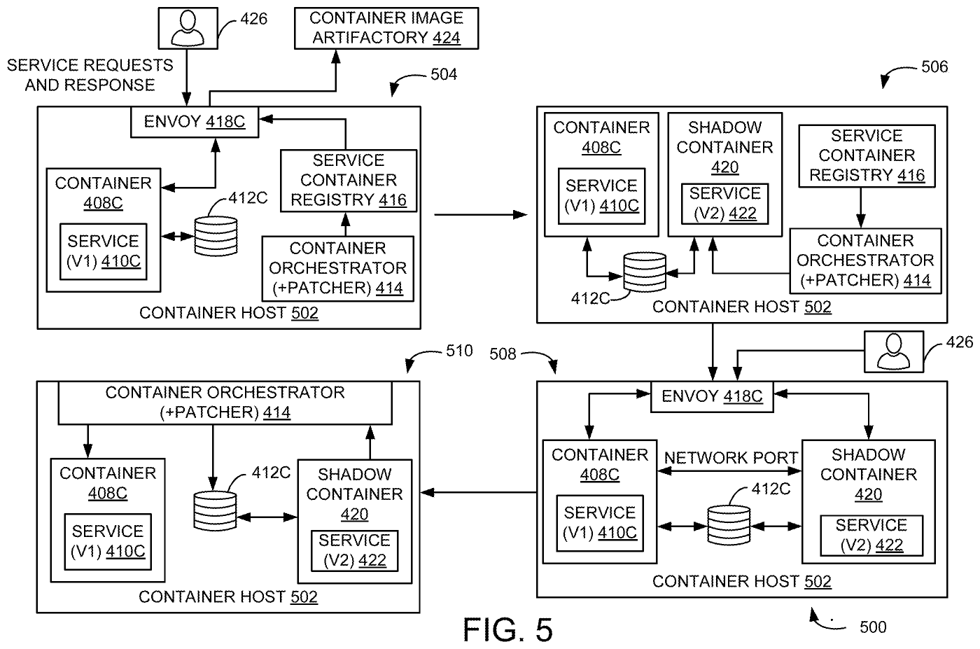

Referring back to FIG. 1, container platform 102 may include container orchestrator 104 to monitor and manage containerized services 114A and 114B. Thus, examples described herein may manage aspects of a containerized service, including lifecycle, communication, and storage, to transform the management application into the containerized microservices architecture. The containerized microservices architecture/framework may facilitate an autonomy of management services, which facilitate running the management application in distributed systems such as a public cloud, an ESXi host (e.g., VMware® vSphere Hypervisor (ESXi) server), and so on, instead of running only in a management appliance. An example block diagram depicting execution of the management application in distributed systems is explained in FIG. 4. The containerized microservices architecture/framework may also facilitate zero downtime upgrade of the management services. An example schematic diagram depicting the upgrade of a containerized service is explained with respect to FIG. 5.

In some examples, the functionalities described in FIG. 1, in relation to instructions to implement functions of container orchestrator 104, service discovery module 106, daemon 108, proxy 110, and any additional instructions described herein in relation to the storage medium, may be implemented as engines or modules including any combination of hardware and programming to implement the functionalities of the modules or engines described herein. The functions of container orchestrator 104, service discovery module 106, daemon 108, and proxy 110 may also be implemented by respective processors. In examples described herein, each processor may include, for example, one processor or multiple processors included in a single device or distributed across multiple devices.

Further, the cloud computing environment illustrated in FIG. 1 is shown purely for purposes of illustration and is not intended to be in any way inclusive or limiting to the embodiments that are described herein. For example, a typical cloud computing environment would include remote servers (e.g., endpoints), which may be distributed over multiple data centers, which might include many other types of devices, such as switches, power supplies, cooling systems, environmental controls, and the like, which are not illustrated herein. It will be apparent to one of ordinary skill in the art that the example shown in FIG. 1 as well as all other figures in this disclosure have been simplified for ease of understanding and are not intended to be exhaustive or limiting to the scope of the idea.

FIG. 4 is a block diagram of an example distributed system 400, depicting containerized services 410A, 410B, and 410C deployed across multiple server platforms. For example, a server platform may include a management appliance 402 (e.g., VMware vCenter®) server), a host server (e.g., VMware® vSphere Hypervisor (ESXi) server) in an on-premises data center 404, a host server in a public cloud 406, or the like. In the example shown in FIG. 4, management services 410A-410C are deployed in containers 408A-408C. Further, containers 408A-408C are deployed across different server platforms. For example, containerized service 410A is deployed in management appliance 402, containerized service 410B is deployed in on-premises data center 404, and containerized service 410C is deployed in public cloud 406. Further, each of management appliance 402, on-premises data center 404, and public cloud 406 may include a respective one of databases 412A, 412B, and 412C. Each database may include configuration data that is common to all containerized services running within the server platform.

Further, distributed system 400 may include a container orchestrator and patcher 414 and service container registry 416 deployed in a respective one of the server platforms. In the example shown in FIG. 4, container orchestrator and patcher 414 is deployed in management appliance 402 and service container registry 416 is deployed in on-premises data center 404. The structure and/or functions of container orchestrator and patcher 414 is similar to container orchestrator 104 described in FIG. 1.

In an example, service container registry 416 may include metadata to discover the management services. A service discovery module (e.g., service discovery module 106 of FIG. 1) may control communication between the containerized services by querying service container registry 416 to get other service's metadata (e.g., a name of the other service) as long as the service is in the same platform. In this example, the services can be discovered by their names, internet protocol (IP), and/or associated port numbers that can be provided by the metadata maintained in container service registry 416. The service-to-service communication may be enabled when the containerized services belong to the same network.

When the containerized services are running on different server platforms, an encrypted overlay network that spans the different server platforms may be employed to enable communication between the containerized services. In this example, an overlay network spanning (i.e., which spans over the different systems that are involved) all these different systems will be created. A feature in the overlay network may allow communication to happen in an encrypted fashion. The overlay network may use container service registry 416 to get the service metadata and establish the service-to-service communication. These services may attach themselves to the overlay network. In this example, an envoy (e.g., envoy 418A, 418B, or 418C) may be used only as a proxy between the internal services and external world (e.g., the envoy may be used for platform-to-platform services, a host server (e.g., a container host) to outside world for downloading, end user communication with the services, and the like), and not for service-service communication.

In the example shown in FIG. 4, management appliance 402 may include an envoy 418A, a host server in an on-premises data center 404 may include an envoy 418B, and a host server in a public cloud 406 may include an envoy 418C. An example of the envoy may be a proxy to enable communication between the services and an external application in an external device. When the services run on different host servers, the envoy may handle routing of requests between one host to another. The envoy may include information to route the requests between the services to give one platform for managing the virtualization infrastructure. Further, distributed system 400 may include a container image artifactory 424 (e.g., a docker hub), which is a hosted repository service provided by a docker for finding and sharing container images. Each service may publish its latest version image in container image artifactory 424 when they are ready, independent of any other services. Further, an administrator may oversee monitoring, managing, upgrading of the virtualization infrastructure using an administrator device 426.

Further, container orchestrator and patcher 414 may perform an upgrade of a containerized service (e.g., service 410C). To upgrade containerized service 410C, container orchestrator and patcher 414 may deploy a shadow container 420 executing an upgraded version 422 as explained in FIG. 5.

FIG. 5 is an example schematic diagram 500, depicting a container orchestrator and patcher 414 to upgrade a containerized service (V1) 410C. Similarly named elements of FIG. 5 may be similar in structure and/or function to elements described in FIG. 4. Container host 502 may be a host server running in a public cloud (e.g., public cloud 406 of FIG. 4). In an example, container orchestrator and patcher 414 may determine an availability of an upgraded version of a first containerized service (e.g., service 410C) of the containerized services by polling an upgrade server (e.g., service container registry 416), as shown in 504. Further, based on the availability of the upgraded version, container orchestrator and patcher 414 may download a container image associated with the upgraded version from the upgrade server (e.g., service container registry 416). Furthermore, based on the container image associated with the upgraded version, container orchestrator and patcher 414 may deploy a shadow container 420 executing upgraded version (V2) 422 of the first containerized service (V1) 410C on container host 502, as shown in 506. For example, V1 and V2 may refer to version 1 and version 2 of the first containerized service. Further, container orchestrator and patcher 414 may disable version 1 of first containerized service 410C subsequent to causing an initiation of the upgraded version V2.

In an example, upon deploying shadow container 420, container orchestrator and patcher 414 may execute both versions, i.e., first containerized service (V1) 410C and upgraded version (V2) 422, to serve incoming requests (e.g., for load balancing) using a common network port, as shown in 508. Further, while executing both first containerized service V1 410C and upgraded version V2 422, container orchestrator and patcher 414 may determine a health status of upgraded version V2 422. In response to determining that the health status of upgraded version V2 422 is greater than a threshold, container orchestrator and patcher 414 may disable first containerized service V1 410C, as shown in 510.

In an example, upon deploying shadow container 420, container orchestrator and patcher 414 may execute both first containerized service V1 410C and upgraded version V2 422 to serve incoming requests. Further, while executing both first containerized service V1 410C and upgraded version V2 422, container orchestrator and patcher 414 may perform migration of database 412C associated with a first containerized service V1 410C to be compatible with upgrade version V2 422 using an expand and contract pattern. For example, the expand and contract pattern may be used to transition data from an old data structure associated with an initial version (V1) of first containerized service 410C to a new data structure associated with upgraded version (V2) 422. In the example shown in FIG. 5, database 412C may be expanded when shadow container 420 is deployed and running in parallel with container 408C, as shown in 506 and 508. Further, database 412C may be contracted when first containerized service (V1) 410C is disabled, as shown in 510.

In some examples, when a service is undergoing a major upgrade, there might be some changes in the database schema. While both the containers (e.g., containers 408C and 420) are running, database 412C may be migrated or converted to make it compatible with both the versions V1 and V2. Upon migrating database 412C, container 408C can be switched off or disabled. To perform the migration of database 412C, the expand and contract pattern may be used. The expand and contract pattern may also facilitate in reverting back the upgrade of first containerized service 410C to a version (V1) during a failure of the upgrade.

For example, container orchestrator and patcher 414 may perform blue/green upgrade of service 410C. Since service 410C is containerized, in an example approach, container orchestrator and patcher 414 may run both services 410C and 422 at the same time by running both versions V1 410C and V2 422 on the same port number. To run both versions 410C and 422 on the same port number, the first requirement is to tweak service (V1) 410C, to allow multiple sockets to bind to the same port. A socket interface option (e.g., SO_REUSEPORT) may be an example port (e.g., a Linux kernel configuration option) that allows multiple services to use the same port number. The socket interface option may allow multiple instances of a service to listen on the same port, and when this happens, the incoming load is automatically distributed. From a developer side, only a simple SO_REUSEPORT parameter has to be set in respective service listener configuration code. Once this change is complete, service 410C may be eligible for zero-downtime upgrade.

An example of container orchestrator and patcher 414 for an overall zero-downtime service upgrade is a systemd service (i.e., a system and service manager for Linux operating systems), running outside container 408C, on container host 502. Further, container orchestrator and patcher 414 may have access to a centralized registry, where all the services' docker images are published. Container orchestrator and patcher 414 may also have a logic for a well-known expand and contract pattern, which will be used to perform a seamless service upgrade.

During a regular polling, when container orchestrator and patcher 414 realizes that a new vCenter service image is available, container orchestrator and patcher 414 may pull the new vCenter service image, along with associated metadata. When service 410C is undergoing a major upgrade, where the database schema changes, the expand hook is called to increase the number of columns for that service database schema. Since database 412C is present inside a dedicated container outside all the services (e.g., 410C), the expansion procedure has no effect on service 410C. Upgraded service container 420 is then started, now running alongside the older instance 408C. For a brief period, both instances run together, servicing the incoming requests. In this example, consider that the older instance 408C is in green and new instance 420 is in red. Container orchestrator and patcher 414 then polls a service health API every few seconds to check if new instance 420 has been completely set up. Once new instance 420 is completely set up, the contract hook is called on the database schema, and after that is successfully done, older container instance 408C is stopped, thereby completing the service upgrade. In this example, older instance 408C turns red and new instance 420 turns green. Then, the older instance 408C can be deleted.

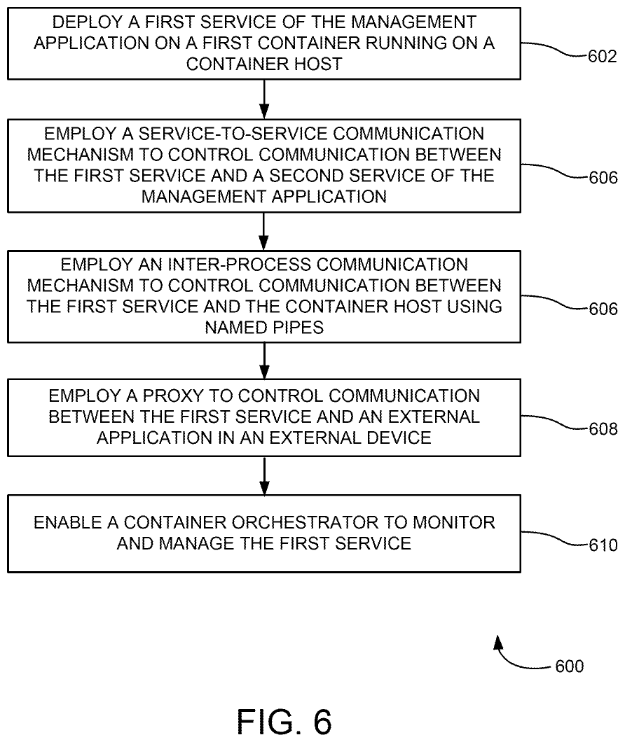

FIG. 6 is a flow diagram illustrating an example method 600 for implementing a microservice architecture for a management application. Example method 600 depicted in FIG. 6 represents generalized illustrations, and other processes may be added, or existing processes may be removed, modified, or rearranged without departing from the scope and spirit of the present application. In addition, method 600 may represent instructions stored on a computer-readable storage medium that, when executed, may cause a processor to respond, to perform actions, to change states, and/or to make decisions. Alternatively, method 600 may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but the flow chart illustrates functional information to design/fabricate circuits, generate computer-readable instructions, or use a combination of hardware and computer-readable instructions to perform the illustrated processes.

At 602, a first service of the management application may be deployed on a first container running on a container host. For example, the container host may include a physical server or a virtual machine running on the physical server. The first container and a second container that runs the second service may be deployed in a server management appliance, an on-premises physical server, a cloud server, or any combination thereof.

In an example, deploying the first service on the first container may include obtaining information about the first service of the management application. The obtained information may include dependency data of the first service. Further, based on the obtained information about the first service, a container file including instructions for building the first container that executes the first service may be generated. Based on the container file, a container image may be created for the first service. Furthermore, based on the container image, the first container may be deployed for execution on the container host.

For containerization of services, a docker container running the first service is needed. To perform the containerization of services, a docker image is created for the first service. The base image may be photon. To create the docker image, all the dependencies of the service may be identified. Then, the docker file may be created with all necessary commands, the dependencies to be installed, and environment variables. Further, using the docker file, a docker image is created, which can be run as a daemon that has the first service running inside a container. For all the containerized services, the information can be shared at a common location (e.g., a shared database).

At 604, a service-to-service communication mechanism may be employed to control communication between the first service and a second service of the management application. When the first service and the second service are running on the same server platform or network, the services can be discovered by their names, Internet protocol (IP) address, and port numbers and the like provided by metadata maintained in a container service registry. The only requirement is for all the services to belong to the same network. When the first service and the second service are running on different server platforms or networks, an encrypted overlay network that spans the different server platforms may be generated to enable communication between the first service and the second service.

At 606, an inter-process communication mechanism may be employed to control communication between the first service and the container host using named pipes. In an example, employing the inter-process communication mechanism to control communication between the first service and the container host may include transmitting a command that need to be executed on the container host from the first container to the container host through a first named pipe. Further, a result associated with an execution of the command from the container host may be transmitted to the first container through a second named pipe.

At 608, a proxy may be employed to control communication between the first service and an external application in an external device. At 610, a container orchestrator may be enabled to monitor and manage the first service. In an example, enabling the container orchestrator to monitor and manage the first service may include determining that an upgraded version of the first service is available by polling an upgrade server. Further, a container image associated with the upgraded version may be downloaded from the upgrade server. Based on the container image associated with the upgraded version, a shadow container executing the upgraded version of the first service may be deployed on the container host. Further, the first service may be disabled subsequent to causing an initiation of the shadow container.

In an example, prior to disabling the first service, both the first service and the upgraded version may be executed to serve incoming requests upon deploying the shadow container. Further, while executing both the first service and the upgraded version, migration of database associated with the first service to be compatible with the upgrade version may be performed using an expand and contract pattern. The expand and contract pattern may be used to transition data from an old data structure associated with a first version to a new data structure associated with the upgraded version.

In an example, disabling the first service may include executing both the first service and the upgraded version to serve incoming requests using a common network port upon deploying the shadow container. Further, a service health application programming interface (API) may be polled at defined intervals to determine a health status of the upgraded version of the first service. In response to determining that the health status of the upgraded version is greater than a threshold, the first service may be disabled.

Further, example method 600 may include configuring a common data model (CDM) that is shared between the first container and a second container that runs a second service of the management application. The CDM may include database and configuration data of the first service and second service.

Further, when the first service and the second service are running on different server platforms, an encrypted overlay network that spans the different server platforms may be generated to enable communication between the first service and the second service.

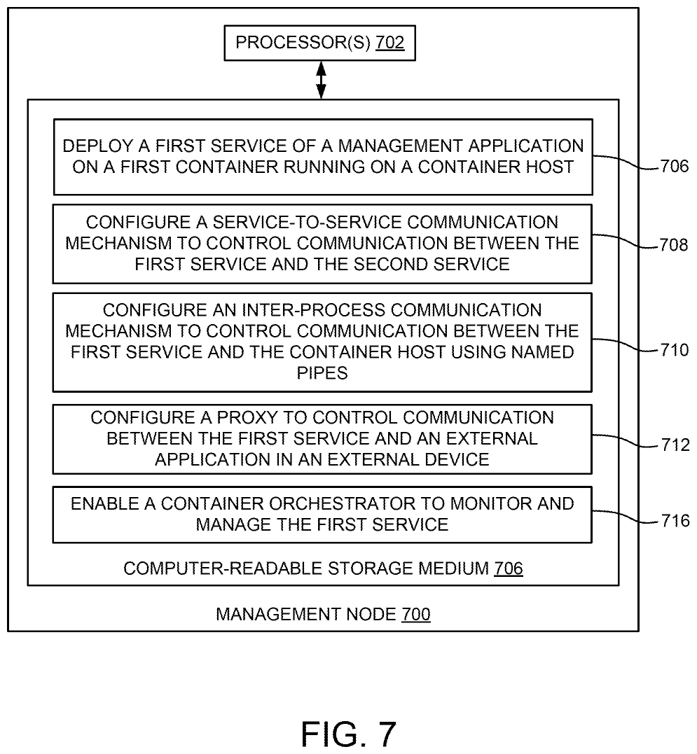

FIG. 7 is a block diagram of an example management node 700 including non-transitory computer-readable storage medium 704 storing instructions to transform a management application into a microservices architecture. Management node 700 may include a processor 702 and computer-readable storage medium 704 communicatively coupled through a system bus. Processor 702 may be any type of central processing unit (CPU), microprocessor, or processing logic that interprets and executes computer-readable instructions stored in computer-readable storage medium 704. Computer-readable storage medium 704 may be a random-access memory (RAM) or another type of dynamic storage device that may store information and computer-readable instructions that may be executed by processor 702. For example, computer-readable storage medium 704 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 704 may be a non-transitory computer-readable medium. In an example, computer-readable storage medium 704 may be remote but accessible to management node 700.

Computer-readable storage medium 704 may store instructions 706, 708, 710, 712, and 714. Instructions 706 may be executed by processor 702 to deploy a first service of a management application on a first container running on a container host. In an example, instructions 706 to deploy the first service on the first container may include instructions to obtain information about the first service of the management application. The obtained information may include dependency data of the first service. Based on the obtained information about the first service, a container file including instructions for building the first container that executes the first service may be generated. Further, based on the container file, a container image may be created for the first service. Furthermore, based on the container image, the first container may be deployed for execution on the container host.

Instructions 708 may be executed by processor 702 to configure a service-to-service communication mechanism to control communication between the first service and the second service. Instructions 710 may be executed by processor 702 to configure an inter-process communication mechanism to control communication between the first service and the container host using named pipes. In an example, instructions 710 to configure the inter-process communication mechanism may include instructions to configure a first named pipe to transmit a command that need to be executed on the container host from the first container to the container host. Further, a second named pipe may be configured to transmit a result associated with an execution of the command from the container host to the first container.

Instructions 712 may be executed by processor 702 to configure a proxy to control communication between the first service and an external application in an external device. Instructions 714 may be executed by processor 702 to enable a container orchestrator to monitor and manage the first service. In an example, instructions 714 to cause the container orchestrator to monitor and manage the first service may include instructions to determine an availability of an upgraded version of the first service by polling an upgrade server. Further, based on the availability of the upgraded version, a container image associated with the upgraded version may be downloaded from the upgrade server. Furthermore, based on the container image associated with the upgraded version, a shadow container executing the upgraded version of the first service may be deployed on the container host. Further, the first service may be disabled subsequent to causing an initiation of the shadow container.

In an example, instructions to disable the first service may include instructions to execute both the first service and the upgraded version to serve incoming requests using a common network port upon deploying the shadow container. Further, a service health application programming interface (API) may be polled at defined intervals to determine a health status of the upgraded version of the first service. Further, in response to determining that the health status of the upgraded version is greater than a threshold, the first service may be disabled.

In an example, prior to disabling the first service, the instructions may include executing both the first service and the upgraded version to serve incoming requests upon deploying the shadow container. Further, while executing both the first service and the upgraded version, migration of the database associated with the first service to be compatible with the upgrade version may be performed using an expand and contract pattern. In an example, the expand and contract pattern may be used to transition data from an old data structure associated with a first version to a new data structure associated with the upgraded version.

Further, computer-readable storage medium 704 may store instructions to configure a common data model (CDM) that is shared between the first container and a second container that runs a second service of the management application. In an example, the CDM may include database and configuration data of the first service and second service.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not be meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A method for implementing a microservice architecture for a management application, the method comprising:
deploying a first service of the management application on a first container running on a container host;
employing a service-to-service communication mechanism to control communication between the first service and a second service of the management application;
employing an inter-process communication mechanism to control communication between the first service and the container host using named pipes;
employing a proxy to control communication between the first service and an external application in an external device; and
enabling a container orchestrator to monitor and manage the first service.

2. The method of claim 1, wherein deploying the first service on the first container comprises:
obtaining information about the first service of the management application, wherein the obtained information comprises dependency data of the first service;
based on the obtained information about the first service, generating a container file including instructions for building the first container that executes the first service;
based on the container file, creating a container image for the first service; and
based on the container image, deploying the first container for execution on the container host.

3. The method of claim 1, wherein enabling the container orchestrator to monitor and manage the first service comprises:
determining that an upgraded version of the first service is available by polling an upgrade server;
downloading a container image associated with the upgraded version from the upgrade server;
based on the container image associated with the upgraded version, deploying a shadow container executing the upgraded version of the first service on the container host; and
disabling the first service subsequent to causing an initiation of the shadow container.

4. The method of claim 3, wherein disabling the first service comprises:
upon deploying the shadow container, executing both the first service and the upgraded version to serve incoming requests using a common network port;
polling a service health application programming interface (API) at defined intervals to determine a health status of the upgraded version of the first service;
in response to determining that the health status of the upgraded version is greater than a threshold, disabling the first service.

5. The method of claim 3, wherein prior to disabling the first service comprises:
upon deploying the shadow container, executing both the first service and the upgraded version to serve incoming requests; and
while executing both the first service and the upgraded version, performing migration of database associated with the first service to be compatible with the upgrade version using an expand and contract pattern, wherein the expand and contract pattern is used to transition data from an old data structure associated with a first version to a new data structure associated with the upgraded version.

6. The method of claim 1, wherein employing the inter-process communication mechanism to control communication between the first service and the container host comprises:
transmitting a command that need to be executed on the container host from the first container to the container host through a first named pipe; and
transmitting a result associated with an execution of the command from the container host to the first container through a second named pipe.

7. The method of claim 1, further comprising:
configuring a common data model (CDM) that is shared between the first container and a second container that runs a second service of the management application, wherein the CDM comprises database and configuration data of the first service and second service.

8. The method of claim 1, further comprising:
when the first service and the second service are running on different server platforms, generating an encrypted overlay network that spans the different server platforms to enable communication between the first service and the second service.

9. The method of claim 1, wherein the container host comprises a physical server or a virtual machine running on the physical server.

10. The method of claim 1, wherein the first container and a second container that runs the second service are deployed in a server management appliance, an on-premises physical server, a cloud server, or any combination thereof.

11. A non-transitory computer readable storage medium comprising instructions executable by a processor of a management node to:
deploy a first service of a management application on a first container running on a container host;
configure a service-to-service communication mechanism to control communication between the first service and the second service;
configure an inter-process communication mechanism to control communication between the first service and the container host using named pipes;
configure a proxy to control communication between the first service and an external application in an external device; and
enable a container orchestrator to monitor and manage the first service.

12. The non-transitory computer readable storage medium of claim 11, wherein instructions to deploy the first service on the first container comprise instructions to:
obtain information about the first service of the management application, wherein the obtained information comprises dependency data of the first service;
based on the obtained information about the first service, generate a container file including instructions for building the first container that executes the first service;
based on the container file, create a container image for the first service; and
based on the container image, deploy the first container for execution on the container host.

13. The non-transitory computer readable storage medium of claim 11, wherein instructions to cause the container orchestrator to monitor and manage the first service comprise instructions to:
determine an availability of an upgraded version of the first service by polling an upgrade server;
based on the availability of the upgraded version, download a container image associated with the upgraded version from the upgrade server;
based on the container image associated with the upgraded version, deploy a shadow container executing the upgraded version of the first service on the container host; and
disable the first service subsequent to causing an initiation of the shadow container.

14. The non-transitory computer readable storage medium of claim 13, wherein instructions to disable the first service comprise instructions to:
upon deploying the shadow container, execute both the first service and the upgraded version to serve incoming requests using a common network port;
poll a service health application programming interface (API) at defined intervals to determine a health status of the upgraded version of the first service;
in response to determining that the health status of the upgraded version is greater than a threshold, disable the first service.

15. The non-transitory computer readable storage medium of claim 13, wherein prior to disabling the first service comprises:
upon deploying the shadow container, execute both the first service and the upgraded version to serve incoming requests; and
while executing both the first service and the upgraded version, performing migration of the database associated with the first service to be compatible with the upgrade version using an expand and contract pattern, wherein the expand and contract pattern is used to transition data from an old data structure associated with a first version to a new data structure associated with the upgraded version.

16. The non-transitory computer readable storage medium of claim 11, wherein instructions to configure the inter-process communication mechanism comprise instructions to:
configure a first named pipe to transmit a command that need to be executed on the container host from the first container to the container host; and
configure a second named pipe to transmit a result associated with an execution of the command from the container host to the first container.

17. The non-transitory computer readable storage medium of claim 11, further comprising instructions to:
configure a common data model (CDM) that is shared between the first container and a second container that runs a second service of the management application, wherein the CDM comprises database and configuration data of the first service and second service.

18. A computer system for transforming a management application into a microservices architecture, comprising:
a container platform to execute containerized services of a management application, wherein the container platform comprises a plurality of containers, each container executing a containerized service;
a service discovery module to control communication between the containerized services within the container platform using an application programming interface (API)-based communication;
a daemon running on the container platform to orchestrate communication between the containerized services and the container platform using named pipes;
a proxy running on the container platform to control communication between the containerized services and an external device; and
a container orchestrator to monitor and manage the containerized services.

19. The computer system of claim 18, wherein the container orchestrator is to:
determine an availability of an upgraded version of a first containerized service of the containerized services by polling an upgrade server;
based on the availability of the upgraded version, download a container image associated with the upgraded version from the upgrade server;
based on the container image associated with the upgraded version, deploy a shadow container executing the upgraded version of the first containerized service on the container host; and
disable the first containerized service subsequent to causing an initiation of the upgraded version.

20. The computer system of claim 19, wherein the container orchestrator is to:
upon deploying the shadow container, execute both the first containerized service and the upgraded version to serve incoming requests using a common network port;
while executing both the first containerized service and the upgraded version, determine a health status of the upgraded version of the first containerized service;
in response to determining that the health status of the upgraded version is greater than a threshold, disable the first containerized service.

21. The computer system of claim 19, wherein the container orchestrator is to:
upon deploying the shadow container, execute both the first containerized service and the upgraded version to serve incoming requests; and
while executing both the first containerized service and the upgraded version, perform migration of the database associated with the first containerized service to be compatible with the upgrade version using an expand and contract pattern, wherein the expand and contract pattern is used to transition data from an old data structure associated with an initial version of the first containerized service to a new data structure associated with the upgraded version.

22. The computer system of claim 19, wherein each container of the plurality of containers comprises a first named pipe and a second named pipe, and wherein the daemon is to orchestrate communication between the containerized services and the container platform by:
transmitting a command that need to be executed on the container platform from a first container of the plurality of containers to the container platform through a first named pipe; and
transmitting a result associated with an execution of the command from the container platform to the first container through a second named pipe.

23. The computer system of claim 18, further comprising:
when the containerized services are running on different server platforms, an encrypted overlay network that spans the different server platforms to enable communication between the containerized services.

24. The computer system of claim 18, further comprising a common data model (CDM) shared between the plurality of containers, wherein the CDM comprises database and configuration data that are common to the containerized services.

25. The computer system of claim 18, wherein the container platform comprises a physical server or a virtual machine running on the physical server.

26. The computer system of claim 18, wherein the plurality of containers is deployed in a server management appliance, an on-premises physical server, a cloud server, or any combination thereof.
